(19) United States
(12) Patent Application Publication
(10) Pub. No.: US 2004/0103235 A1
(43) Pub. Date: May 27, 2004

(54) USB based terminal device

(76) Inventor: Pei-Chung Liu, ChungHo City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/304,687

(22) Filed: Nov. 27, 2002

(51) Int. Cl. G06F 13/20

(52) U.S. Cl. 710/313

(57) ABSTRACT

A USB based terminal device is coupled to a host computer to establish a USB connection therebetween and serve as a terminal of the host computer. The terminal device includes a display, such as a liquid crystal display, connected to a secondary display interface of the host computer to receive messages from the host computer whereby the display of the terminal device is able to provide a secondary display in addition to the primary display of the host computer. The terminal device also includes a keyboard for user entering data and instruction to the terminal device. The terminal device also includes a USB hub circuit to which the keyboard is connected. The USB hub circuit includes at least one USB port connected to a USB interface port of the host computer to forward the data and instructions entered via the keyboard to the host computer whereby the user of the terminal device is capable to share the resources of the host computer. The USB hub circuit may selectively include a sound controller to receive and give sound signals via sound input and output devices, a mouse port to which a mouse is connected, and a communication interface for connection with a modem. If desired, a PS2/USB conversion circuit is integrated with the USB hub circuit for selective connection with PS2 based peripheral devices, such as PS2 keyboard and PS2 mouse.

### BACKGROUND OF THE INVENTION

1. Field of the Invention

The present invention generally relates to a computer terminal device coupled to a host computer, and in particular to a USB based terminal device that allows for share of resources of the host computer between users of the computer system.

2. The Related Art

A computer network comprises a plurality of individual computers interconnected with each other. In certain applications, network resources are provided by one or some of the computers, which are server computers, while the other computers, the client computers, provide functions of input and output only. An example of such a computer system is a network game system. Thus, sophisticated storage and additional peripheral devices are indeed not required for each individual computer. Software and storage can be obtained by sharing with the servers. This reveals the fact that using a standard personal computer that includes its own storage and other devices as a client computer is a waste of computer resources and is costly.

### SUMMARY OF THE INVENTION

Thus, an object of the present invention is to provide a USB based terminal device that functions as a client computer with respect to a host computer to which the terminal device is connected.

Another object of the present invention is to provide a terminal device connected to a host computer to allow a number of users to share the computer resources of the host computer without installing additional computers.

To achieve the above objects, in accordance with the present invention, there is provided a USB based terminal device adapted to couple to a host computer to establish a USB connection therebetween and serve as a terminal of the host computer. The terminal device comprises a display, such as a liquid crystal display, connected to a secondary display interface of the host computer to receive messages from the host computer whereby the display of the terminal device is able to provide a secondary display in addition to the primary display of the host computer. The terminal device also comprises a keyboard for user entering data and instruction to the terminal device. The terminal device also includes a USB hub circuit to which the keyboard is connected. The USB hub circuit comprises at least one USB port connected to a USB interface port of the host computer to forward the data and instructions entered via the keyboard to the host computer whereby the user of the terminal device is capable to share the resources of the host computer. The USB hub circuit may selectively comprise a sound controller to receive and give sound signals via sound input and output devices, a mouse port to which a mouse is connected, and a communication interface for connection with a modem. If desired, a PS2/USB conversion circuit is integrated with the USB hub circuit for selective connection with PS2 based peripheral devices, such as PS2 keyboard and PS2 mouse.

### BRIEF DESCRIPTION OF THE DRAWINGS

The present invention will be apparent to those skilled in the art by reading the following description of preferred embodiments thereof, with reference to the attached drawings, in which:

FIG. 1 is a block diagram of a computer system in which a terminal device in accordance with a first embodiment of the present invention is embodied;

FIG. 2 is a flow chart showing the operation of the terminal device of the present invention;

FIG. 3 is a block diagram of a computer system in which a terminal device in accordance with a second embodiment of the present invention is embodied;

FIG. 4 a block diagram of a computer system in which a terminal device in accordance with a third embodiment of the present invention is embodied; and

FIG. 5 is a schematic view showing an application of the terminal device of the present invention.

### DETAILED DESCRIPTION OF THE PREFERRED EMBODIMENTS

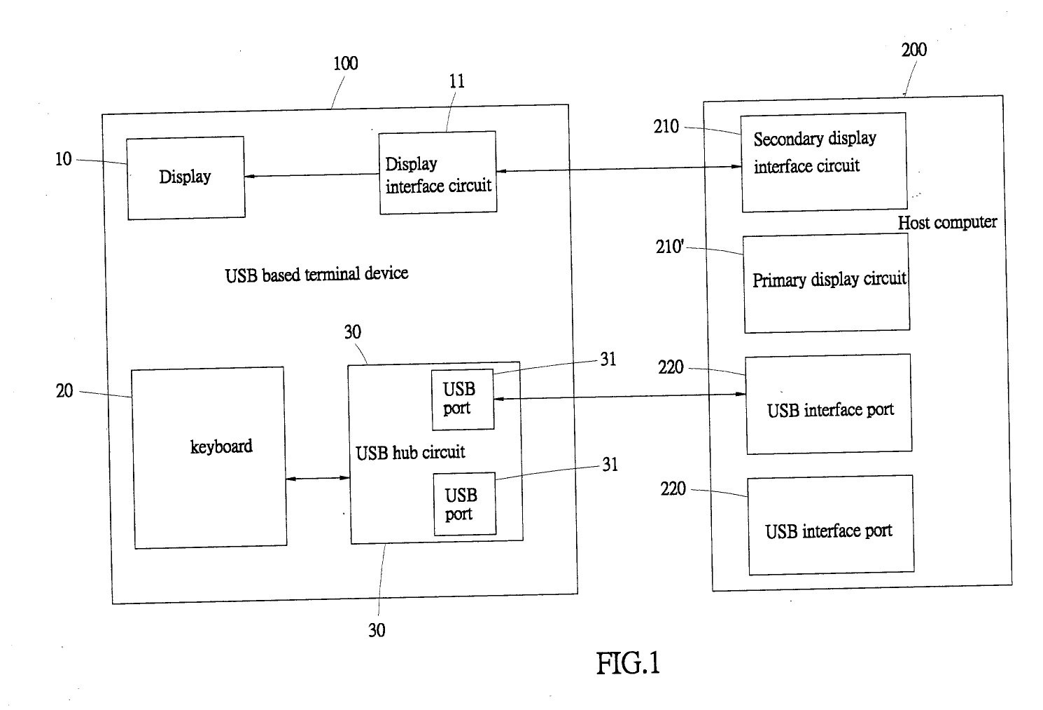

With reference to the drawings and in particular to FIG. 1, a computer system comprises a host computer, generally designated with reference numeral 200, to which at least one terminal device constructed in accordance with the present invention, generally designated with reference numeral 100, is connected. The terminal device 100 comprises a display 10, a keyboard 20 and a USB hub circuit 30. The display 10 can be of any type comprising an interface circuit 11 coupled to a secondary display interface circuit 210 of the host computer 200 for receiving signals or messages to be displayed from the host computer 200. An example of the display 10 is a liquid crystal display (LCD) panel. Besides the secondary display interface circuit 210, the host computer 200 also has a primary display circuit 210′. An example is a computer running under the operating systems WINDOWS 2000 and WINDOWS XP (both being trademarks of Microsoft Corporation), which is capable to manage up to nine displays. This constitutes no novel part of the present invention and will not be further discussed. It is only noted that the host computer 200 is capable to handle at least two displays of which one is coupled to the terminal device 100.

To simplify the overall structure, the display 10 may be integrated with the keyboard 20 as a unitary device. Alternatively, they can be separate devices. The keyboard 20 is connected to the USB hub circuit 30. Data or instructions entered through the keyboard 20 are conveyed to the USB hub circuit 30 first. The USB hub circuit 30 comprises a number of USB ports 31. One of the USB ports 31 is coupled to a USB interface port 220 of the host computer 200 so as to electrically couple the keyboard 20 of the terminal device 100 or other peripheral devices that are connected to the USB hub circuit 30 of the terminal device 100 to the host computer 200. It is noted that the host computer 200 may comprise a number of USB interface ports 220 for connection with a number of terminal devices 100.

The connection between the USB hub circuit 30 of the terminal device 100 and the USB interface port 220 of the host computer 200 allows the terminal device 100 to access resources of the host computer 200, such as operating the application software installed in the host computer 200, while the connection between the display 10 and the secondary display interface 210 of the host computer 200 allows for display of messages from the host computer 200 on the display 10 of the terminal device 100. Thus, input and output communication between the terminal device 100 and the host computer 200 is properly established.

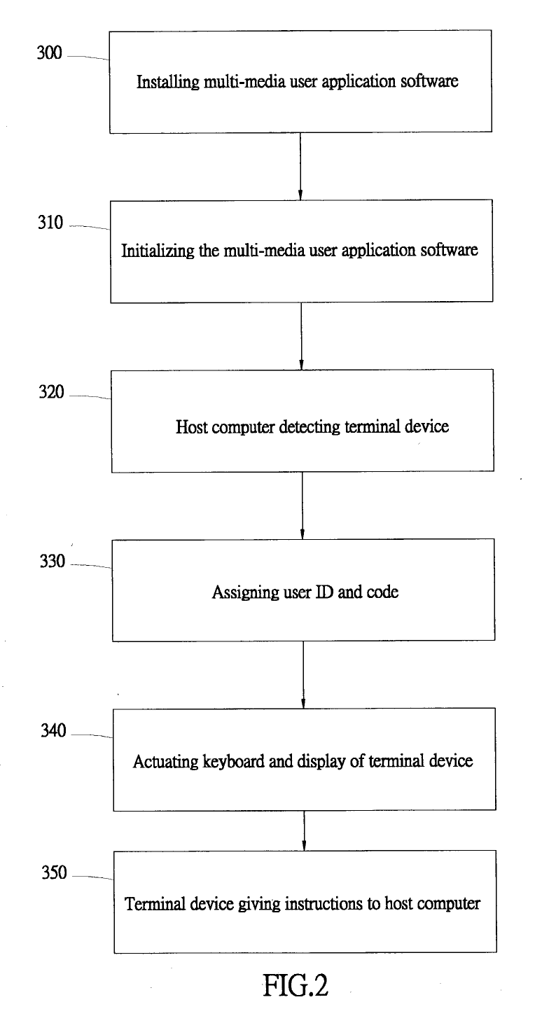

Also referring to FIG. 2, the operation of the terminal device 100 is shown in the flow chart of FIG. 2. In step 300, multi-media user application software is first established in the host computer 200. In other words, the multi-media user application software is installed in the host computer 200 in advance. The software allows a number of users to share the application software installed in the host computer 200. Since the multi-media user application software constitutes no novel part of the present invention and is known to those familiar with computer software, no further detail will be given herein.

In step 310, the multi-media user application software is initialized or executed. In step 320, the host computer 200 detects the terminal device 100 of the present invention by means of the USB interface port 220 thereof to determine if the terminal device 100 is coupled thereto. In step 330, user ID and code are established and assigned to each terminal device 100 that is coupled to the host computer 200. In other words, the multi-media user application software of the host computer 200 assigns a user code and ID to each terminal device 100 that is coupled to the USB interface 220 of the host computer 200.

In step 340, the keyboard 20 and the display 10 of the terminal device 100 are actuated and in step 350, an instruction of operating application software that is given by a user is sent to the host computer 200 via the terminal device 100.

By following the above process, steps 300-350, the terminal device 100 is capable to access and execute the application software of the host computer 200 and also share the data of the host computer 200. Associated messages of the process and the operation of the application software are displayed on the display 10 of the terminal device 100 for the observation of the user.

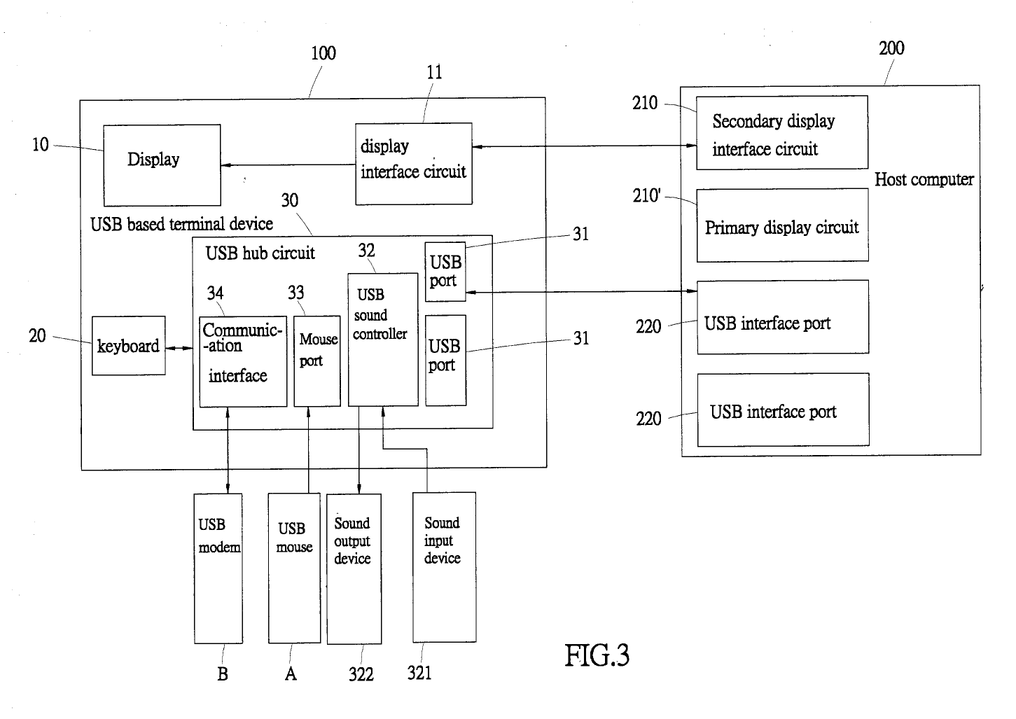

FIG. 3 shows a second embodiment of the terminal device 100 in accordance with the present invention, wherein the USB hub circuit 30 of the terminal device 100 of the second embodiment comprises a USB sound controller 32. An external sound input device 321 and an external sound output device 322 are selectively connected to the sound controller 32 whereby the terminal device 100 may receive external sounds from the sound input device 321 and/or delivery and broadcast sounds via the sound output device 322. Examples of the sound input device 321 are a microphone and an audio output of an optic disk drive. The sound controller 32 receives corresponding signals of the external sound and forwards the signals to the host computer 200 via the USB port 31. Application software in the host computer 200 may then process the sound in desired manner. An example of the sound output device 322 is a loud speaker. Sounds in electronic form are transmitted from the host computer 200 to the USB hub circuit 30 of the terminal device 100 and processed by the sound controller 32. Thereafter, the signals are forwarded to the loud speaker and broadcast thereby.

The mouse port 33 allows for selective connection with a computer mouse A. The operation of the computer mouse A gives signals corresponding to movement of a cursor and the signals are transmitted to the host computer 200 via the USB hub circuit 30 for controlling the operation of application software executed in the host computer 200.

The communication interface 34 allows for selective connection with a USB based modem B. By means of the modem B, the terminal device 100 is allowed to connect to for example the Internet and retrieve desired data and information from the Internet. The data and information so obtained from the Internet can be transmitted to the host computer 200 via the USB hub circuit 30 of the terminal device 100. The modem B is actuated by application software running in the host computer 200 via the USB hub circuit 30.

The second embodiment of the terminal device in accordance with the present invention illustrates the possibility of not only sharing resources of the host computer 200 by the terminal device 100, but also allowing for multi-media application of the terminal device 100 on the host computer 200, namely input and output of audio and video signals and accessibility of computer mouse.

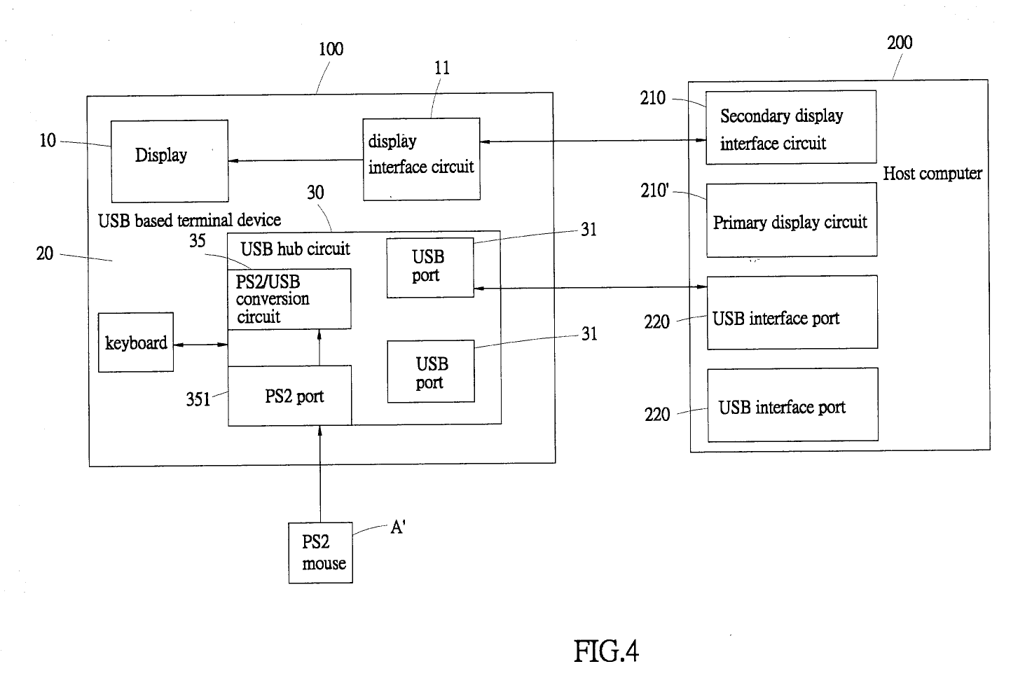

FIG. 4 shows a third embodiment of the terminal device 100 in accordance with the present invention wherein the USB hub circuit 30 comprises a PS2/USB conversion circuit 35 to which a PS2 port 351 is connected. The PS2 port 351 allows for selective connection with a PS2 mouse A′ for receiving cursor signals from the PS2 mouse A′ and the PS2/USB conversion circuit 35 converts the PS2 cursor signals into corresponding USB based signals which are then transmitted to the host computer 200 via the USB port 31. Thus, a PS2 mouse A′ can be employed in the computer system. Similarly, a PS2 keyboard can also be used in the system by plugging to the PS2 port 351.

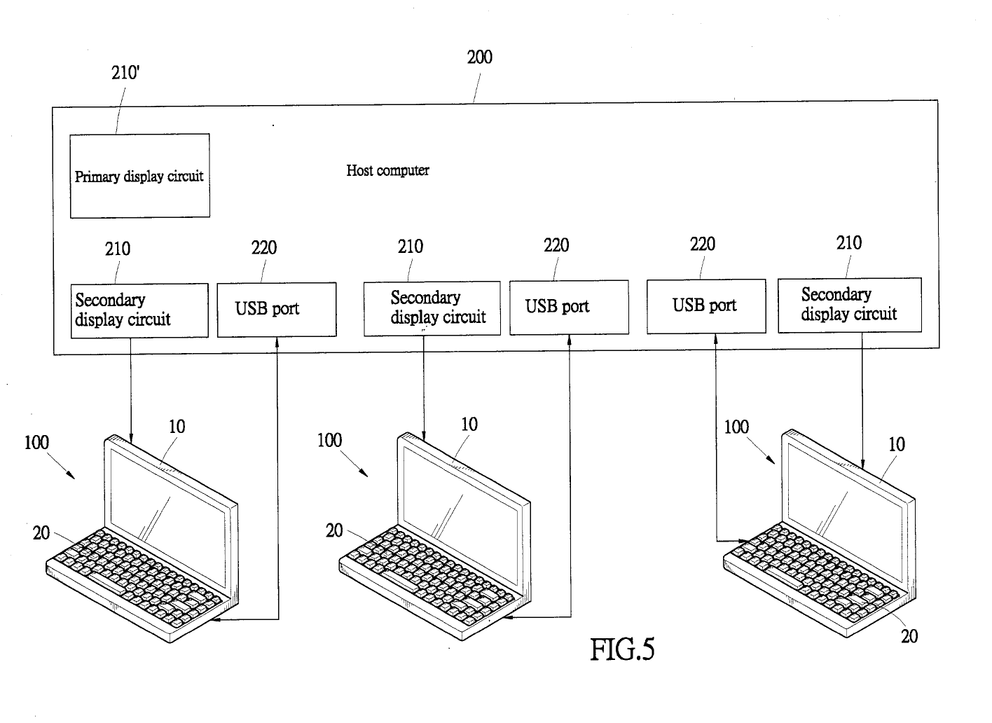

FIG. 5 shows an application of the terminal device 100 of the present invention in a computer system wherein the host computer 200 comprises a number of sets of secondary display interfaces 210 and USB interface ports 220, each set allowing for connection with a terminal device 100. Thus, a number of terminal devices 100 are connected to the host computer 200 and share the resources of the host computer 200. The connection between each terminal device 100 and the host computer 200 is done readily with USB cable connection. Thus, the terminal devices 100 may be readily added to and removed from the host computer 200. Overall costs of the computer system are reduced by replacing the costly personal computers with the cheap terminal devices 100 of the present invention. Networking cost is also reduced due to the ready USB connection. The present invention is very suitable for network game systems and on-line financial data systems in which the data are stored and processed mainly in the server computer (the host computer 200), while the client computers that are connected to the server computer do not need sophisticated structure and function and can be replaced by the terminal device of the present invention. It is noted that the high speed and wide band transfer of data provided by the USB connection allows for efficient data accessibility of the host computer by the terminal device.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A USB based terminal device adapted to couple to a host computer in a USB based manner to serve as a terminal of the host computer, the terminal device comprising:
a display adapted to connect to a secondary display interface of the host computer to receive messages from the host computer;
a keyboard; and
a USB hub circuit to which the keyboard is connected, the USB hub circuit comprising at least one USB port adapted to connect to a USB interface port of the host computer to forward data and instructions entered via the keyboard to the host computer.

2. The terminal device as claimed in claim 1, wherein the display comprises a display interface circuit connected to the secondary display interface of the host computer.

3. The terminal device as claimed in claim 1, wherein the display comprises a liquid crystal display.

4. The terminal device as claimed in claim 1, wherein the USB hub circuit comprises a USB sound controller selectively connected to a sound input device and a sound output device.

5. The terminal device as claimed in claim 4, wherein the sound input device comprises a microphone.

6. The terminal device as claimed in claim 4, wherein the sound output device comprises a loud speaker.

7. The terminal device as claimed in claim 1, wherein the USB hub circuit comprises a mouse port to which a computer mouse is selectively connected.

8. The terminal device as claimed in claim 1, wherein the USB hub circuit comprises a communication interface to which a USB modem is selectively connected.

9. The terminal device as claimed in claim 1, wherein the USB hub circuit comprises a PS2/USB interface conversion circuit to which a PS2 port is connected.
